(19) United States
(12) Patent Application Publication
(10) Pub. No.: US 2013/0082899 A1
(43) Pub. Date: Apr. 4, 2013

(54) HIGH-FREQUENCY LINE-WAVEGUIDE CONVERTER

(71) Applicant: Koichiro Gomi, Kanagawa-ken (JP)

(72) Inventor: Koichiro Gomi, Kanagawa-ken (JP)

(73) Assignee: KABUSHIKI KAISHA TOSHIBA, Tokyo (JP)

(21) Appl. No.: 13/607,328

(22) Filed: Sep. 7, 2012

(30) Foreign Application Priority Data
Sep. 30, 2011 (JP) P2011-218757

(51) Int. Cl. H01Q 1/50

(52) U.S. Cl. 343/905

(57) ABSTRACT

A high frequency line-waveguide converter is provided which includes a first substrate including a first dielectric layer, a first conductive layer formed on a surface of the first dielectric layer, and a conductive pattern formed on the surface of the first dielectric layer that surrounds the second conductive layer. An antenna formed on a bottom surface of the first dielectric layer at a fixed interval from the second conductive layer. The high frequency line-waveguide converter also includes a second substrate including a third conductive layer and a fourth conductive layer separated by a second dielectric layer. An adhesion layer formed between the first substrate and second substrate, a shield conductive part formed by multiple vias between the conductive pattern and the fourth conductive layer, and a conductive waveguide in contact with the fourth conductive layer.

### CROSS-REFERENCE TO RELATED APPLICATION

This application is based upon and claims the benefit of priority from Japanese Patent Application No. 2011-218757, filed Sep. 30, 2011; the entire contents of which are incorporated herein by reference.

### FIELD

Embodiments described herein relate to a high frequency line-waveguide converter for converting high frequency signals, such as microwave signals and milliwave signals, etc. from a high frequency line of a plane circuit to the propagation mode of the waveguide.

### BACKGROUND

In recent years, microwaves of 1-30 GHz and milliwaves of 30-300 GHz are used for information transfer, and systems utilizing high frequency signals, for instance, high-capacity communication systems of 60 GHz, or vehicle-mounted radar systems of the 76 GHz band, have been widely used. It is important, in these high frequency circuits, that are used in high frequency systems, to provide reduced-loss connections between high frequency IC's and an antenna. Particularly in systems using milliwave signals, the waveguide very often becomes the interface of the antenna, and broad-band high frequency line-waveguide converters with low loss are needed.

A conventional, high-frequency, line-waveguide converter typically includes a structure of sandwiching a dielectric substrate, with a high frequency line, between a waveguide formed in a rectangular metallic block and a metallic short-circuit block. In the structure utilizing the short-circuit block, external leakage of electromagnetic waves in the mode conversion circuit connecting the high frequency line to the waveguide, is prevented by the short-circuit block.

In the case of installing the short-circuit block, however, there are two problems. First, the short-circuit block needs to separate parts that may cause the short-circuit. Second, the line-waveguide converter requires ample mounting space for mounting the short-circuit block.

Due to these disadvantages, a high frequency line-waveguide converter which does not use short-circuit block has been developed. However, electromagnetic waves easily leak to the outside, and the conversion loss becomes large since the short-circuit structure is constituted in a substrate having large loss and high permittivity as compared with air. Moreover, the matching range band is undesirably narrowed.

### DESCRIPTION OF THE DRAWINGS

FIGS. 1A and 1B are schematic illustrations of a high-frequency line-waveguide converter according to an embodiment; FIG. 1A is a top view, and FIG. 1B is a cross-sectional view along the line A-A of FIG. 1A.

### DETAILED DESCRIPTION

In general, according to one embodiment, a high-frequency line-waveguide converter relating to the embodiment of the present disclosure will be explained in detail by referring to the FIGS.

According to the embodiment, there is provided a broad-band high-frequency line-waveguide converter with low conversion loss.

The high frequency line-waveguide converter in the embodiment has a first substrate including a first dielectric layer, a first conductor layer formed on the top surface of the first dielectric layer, a conductor pattern, which is formed on the top surface of the first dielectric layer in a manner that encapsulates the first conductor layer at regular spacing intervals. A second conductor layer is formed on the bottom surface of the first dielectric layer, and an antenna, which is formed on the bottom surface of the first dielectric layer, but is spaced a fixed interval from the second conductor layer. A second substrate including a second dielectric layer is formed at a second conductor layer side. A third conductor layer is formed on the top surface of the second dielectric layer, and a fourth conductor layer formed on the bottom surface of the second dielectric layer. An adhesion layer is formed between the first substrate and second substrate, a shield conductor part, which is formed as multiple through-holes between the conductor pattern and the fourth conductor, and a waveguide is formed so as to be contacted by, and electrically connected with, the fourth conductor layer.

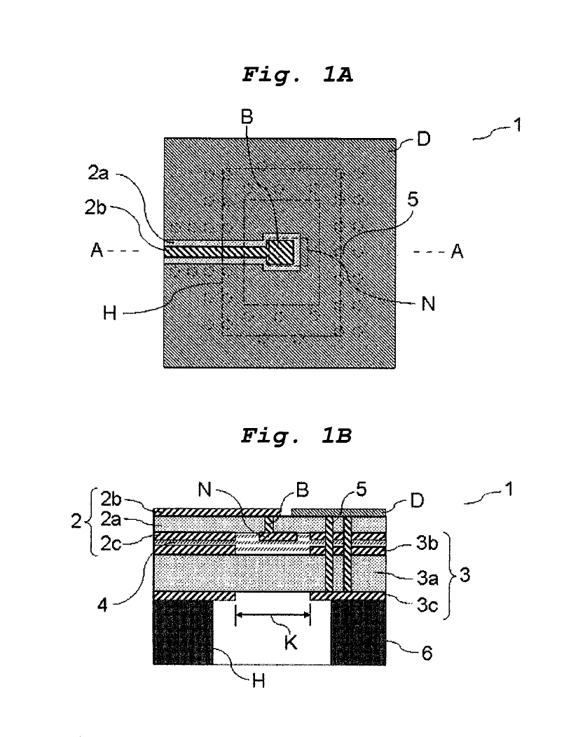

As shown in FIGS. 1A, 1B, the high-frequency line-waveguide converter 1 relating to the embodiment of the invention is composed of first substrate 2, blind via-hole B, antenna N, second substrate 3, adhesion layer 4, sealed conductor part 5 and conductive waveguide 6.

First substrate 2 includes first dielectric layer 2a, first conductor layer 2b and conductor pattern D installed on the top surface of first dielectric layer 2a, and second conductor layer 2c arranged at the bottom surface of first dielectric layer 2a. Conductor pattern D and second conductor layer 2c are a pattern of GND potential (e.g., GND plane) in high frequency. In first substrate 2, there is antenna N which is formed on the bottom surface of first dielectric layer 2a, but at a fixed spacing from second conductor layer 2c.

First conductor layer 2b forms a signal line, which is a high frequency line that is coplanar with one or both of the conductor pattern D and the first dielectric layer 2a in this embodiment. While the first conductor layer 2b is coplanar in this embodiment, first conductor layer 2b is not limited to this constitution, and first conductor layer 2b may be a microstrip line. First conductor layer 2b is connected to a semiconductor chip which is not shown. Further, conductor pattern D is formed so as to enclose first conductor layer 2b while leaving a gap of about 0.1 mm therearound. Antenna N is connected to first conductor layer 2b through blind via-hole B.

Since it is composed as above, the high frequency signal of first conductor 2b can be fed directly to antenna N without the risk of radiation emission to the air layer of the top surface. More particularly, the high-frequency line-waveguide converter 1 can reduce emission losses, without the use of a short-circuit block.

Second substrate 3 is installed so as to be in contact with second conductor layer 2c of first substrate 2 through adhesion layer 4. More specifically, adhesion layer 4 is provided between the second conductor layer 2c and the second substrate 3.

Second substrate 3 includes second dielectric layer 3a, third conductor layer 3b formed on the top surface of second dielectric layer 3a, and fourth conductor layer 3c arranged at the bottom surface of second dielectric layer 3a. Third conductor 3b and fourth conductor layer 3c are patterns of GND potential (e.g., GND planes) in high frequency. An interval K (shown in FIG. 1B) is formed as a space between second conductor 2c. Third and fourth conductor layers 3a, 3c are formed to include the same spacing intervals as the interval K of second conductor layer 2c which is formed at a constant spacing interval with respect to antenna N. This provides a uniform tube width of the dielectric waveguide, and facilitates satisfactory wave propagation therein.

The adhesion layer 4 is formed between first substrate 2 and second substrate 3 so as to surround a part of first and second dielectric layers 2a, 3a, second and third conductor layers 2c, 3b, and antenna N. Furthermore, the adhesion layer is formed from nonconductive materials.

Sealed conductor part 5 is a through-hole formed between conductor pattern D and fourth conductor 3c and is installed so as to surround antenna N. In this manner, dielectric waveguide is formed, and, particularly, leakage of electromagnetic waves radiating from antenna N, can be reduced or eliminated.

Furthermore, conductor pattern D, second, third, and fourth conductor layers 2c, 3b, 3c are together patterns of GND potential (e.g., GND planes), and are connected in high frequency to GND potential by the through-hole of the sealed conductor part 5.

Conductive waveguide 6 is installed to be in contact, as well as in electrical conductivity (i.e., communication) with, fourth conductor layer 3c of second substrate 3. In conductive waveguide 6, an opening H is provided, which is wider than the interval K of second conductor layer 2c, is formed at a constant spacing with respect to antenna N as well as interval K.

Dielectric materials used for forming first and second dielectric layers 2a, 3a include ceramic materials containing, as the main component, aluminum oxide, aluminum nitride, silicon nitride, mullite, etc., glass or glass ceramics, obtained by firing a mixture of glass and ceramic filler, organic resin type materials such as epoxy resin, polyimide resin, fluorine-based resin like tetrafluoroethylene resin, etc., and organic resin-ceramic (including glass) composites, etc.

Conductive components include metallic materials, containing, as the main component, tungsten, molybdenum, gold, silver, copper, etc., or metal foil containing, as the main component, gold, silver, copper, aluminum, etc. are used as materials forming first to fourth conductor layers 2b, 2c, 3b, 3c, antenna N, blind via-hole B, and sealed conductor part 5.

The adhesion layer 4 is set to make the distance from the antenna N and the second dielectric layer 2a to the fourth conductor layer 3c in order to provide a λg/4, which becomes an impedance inversion circuit. Furthermore, λg is the in-tube wavelength of dielectric waveguide formed by sealed conductor parts 5.

Since the distance from the antenna N to fourth conductor layer 3c of second substrate 3 is set to provide λg/4, impedance is set so as to satisfy Ze=(Ω)^{1/2} wherein Zp (Ω) is the impedance of antenna N, Ze (Ω) is the characteristic impedance of dielectric waveguide, and Zw (Ω) is the characteristic impedance of conductive waveguide 6.

Antenna N is connected to first conductor 2b through blind via-hole B, but possesses a function of converting the impedance ratio at the high frequency line, including first conductor 2b, and impedance Zp of antenna N, to the appropriate conversion ratio.

The connection position of antenna N and via-hole B is controlled to match the impedance of the high frequency line (e.g., the first conductor layer 2b).

The characteristic impedance of dielectric waveguide becomes about 200-350Ω when the characteristic impedance of first conductor layer 2b in this embodiment is, about 50Ω. The impedance of antenna N is about 100-200Ω and characteristic impedance of conductive waveguide 6 (WR-10, 75-110 GHz) is about 300-600Ω.

Matching of characteristic impedance, about 50Ω, of first conductor layer 2b, and impedance of about 100-200Ω of antenna N, can be controlled by controlling the connection position of blind via-hole B.

Matching the impedance of the antenna N, is also controlled by arranging an impedance inversion circuit between antenna N and conductive waveguide 6. Since impedance conversion is carried out by two conversion circuits between the high frequency line and antenna N, and between antenna N and conductive waveguide 6, widening of the matching range is possible. The band of −20 dB or lower is about 2.5 GHz in the conventional structure, but it becomes about 4 GHz in the high-frequency line-waveguide converter 1, and further band widening can be realized.

Conductive waveguide 6 is composed of metal, for example a noble metal such as gold, silver, etc., and is utilized for reducing conductor loss by electric current and/or corrosion prevention. The metal may be used to coat the tube inner wall within conductive waveguide 6. Materials other than metal may be used for the conductive waveguide 6. For example, a resin may be used by forming the conductive waveguide 6 to the necessary waveguide shape. When resin is used, the tube inner wall is coated with a noble metal, such as gold, silver, etc.

According to the present embodiment, high frequency line-waveguide converter 1 is formed by installing first conductor layer 2b on the top surface of first dielectric layer 2a of first substrate 2 and connecting antenna N, arranged on the bottom surface of first dielectric layer 2a to first conductor layer 2b through blind via-hole B. Next, first conductor layer 2b is enclosed by conductor pattern D installed on the top surface of first dielectric layer 2a. Sealed conductor part 5, which is composed of a plurality of through-hole lines, is formed by providing holes through the conductor pattern D to a depth that provides contact with fourth conductor layer 3c of second substrate 3. The sealed conductor part 5 is formed to surround antenna N, which forms dielectric waveguide. The high-frequency line-waveguide converter 1 is formed so as to make the distance from antenna N to the surface of fourth conductor 3c is set to λg/4.

High frequency lines composed of first conductor layer 2b and antenna N are connected by blind via-hole B, and the high frequency line is enclosed with conductor pattern D so that leakage of electromagnetic radiation to the air layer is inhibited to reduce conversion loss. Furthermore, leakage of electromagnetic waves being emitted from antenna N to the outside of the dielectric waveguide is inhibited by sealed conductor part 5, composed of a plurality of through-hole lines installed so as to enclose antenna N so that conversion loss, is reduced.

Band widening of the matching range can be realized by two impedance conversion circuits, namely, an impedance conversion circuit by dielectric waveguide having length of λg/4 and an impedance conversion circuit composed of the selective connection between the high frequency line and antenna N by blind via-hole B.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A high frequency line-waveguide converter, comprising:
a first substrate including:
a first conductive layer;
a second conductive layer;
a first dielectric layer disposed between the first conductive layer and the second conductive layer, and
a conductive pattern formed on an upper surface of the first dielectric layer so as to surround the first conductive layer with a defined gap therebetween;
a second substrate coupled to the first substrate by an adhesion layer, the second substrate including:
a third conductive layer; and
a fourth conductive layer;
an antenna disposed on the first dielectric layer in a substantially coplanar relationship with the second conductive layer and at a fixed distance from the second conductive layer; and
a sealed conductive part having multiple sections disposed between the conductive pattern and the fourth conductive layer.

2. The high frequency line-waveguide converter of claim 1, wherein the defined gap comprises a portion of the first dielectric layer that electrically isolates the conductive pattern and the first conductive layer.

3. The high frequency line-waveguide converter of claim 1, further comprising a conductive waveguide disposed adjacent the fourth conductive layer, the conductive waveguide in electrical conductivity with the fourth conductive layer.

4. The high frequency line-waveguide converter of claim 1, wherein the sealed conductive part comprises a dielectric waveguide.

5. The high frequency line-waveguide converter of claim 4, wherein a distance between the antenna and the fourth conductive layer is set to provide a λg/4, wherein 2g is an in-tube wavelength of the dielectric waveguide.

6. The high frequency line-waveguide converter of claim 1, wherein a spacing interval is formed between the second conductive layer and the antenna within the adhesion layer.

7. The high frequency line-waveguide converter of claim 6, wherein the third conductive layer includes a gap that is substantially equal to the spacing interval.

8. The high frequency line-waveguide converter of claim 6, wherein the fourth conductive layer includes a gap that is substantially equal to the spacing interval.

9. The high frequency line-waveguide converter of claim 3, wherein the conductive waveguide includes an opening having a dimension that is greater than a spacing interval formed between the second conductive layer and the antenna within the adhesion layer.

10. The high-frequency line-waveguide converter of claim 1, wherein a via hole is disposed in the adhesion layer connecting the first conductive layer to the antenna.
